(19) United States
(12) Patent Application Publication
(10) Pub. No.: US 2004/0071993 A1
(43) Pub. Date: Apr. 15, 2004

(54) Laminated multi-layered weldable flat film for the production of welded tubular films and use thereof

(76) Inventors: Hartmut Grund, Otterstadt (DE); Horst Lang, Weinheim (DE); Helmut Schauer, Mannheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,920

(22) PCT Filed: Feb. 1, 2001
(86) PCT No.: PCT/EP01/01065

(51) Int. Cl. B32B 27/08

(52) U.S. Cl. 428/474.4; 428/476.3

(57) ABSTRACT

The invention relates to laminated, multilayered and weldable flat film for the production of welded tubular films and to the use thereof for wrapping and packaging foodstuffs. The inventive flat film has two weldable surface layers made of at least one copolyamide and at least one amorphous polyamide and/or at least one homopolyamide and/or at least one modified polyolefin, and is produced by laminating at least two single-layered or multilayered and optionally biaxially oriented flat films.

The invention relates to a multilayered, weldable flat film used to produce tubular films by welding in a well-known manner, which tubular films are used in the packaging and wrapping of foodstuffs, particularly pasty foodstuffs, said multilayered flat film being produced by laminating at least two flat films which, in turn, can be single-layered or multilayered and biaxially oriented.

Multilayered, weldable flat films produced by laminating are well-known. Using welding for packaging purposes, all kinds of tubular films can be produced from such multilayered flat films in a well-known fashion by bending the flat film to form a tube and joining the contacting opposite edges by a seal strip extending in longitudinal direction. A second way would be bending the flat film to form a tube by allowing overlap of the opposite edges and welding together the overlapping areas. A third way of forming a tubular film from a flat film is bending the flat film to form a tubular film and welding together the respective opposite edge areas along the length thereof, thereby forming a longitudinal fold where equal sides of the flat film make contact with each other.

In addition to high impermeability to water vapor and oxygen, such films must meet high demands with respect to weldability and, in particular, strength of the weld seam.

The object of the invention is therefore to provide a flat film complying with the above-mentioned preconditions.

Said object is accomplished by means of a multilayered, weldable flat film which is produced by laminating at least two flat films which, in turn, can be single-layered or multilayered and biaxially oriented, and wherein the two weldable surface layers are comprised of at least one copolyamide and at least one amorphous polyamide and/or at least one homopolyamide and/or at least one modified polyolefin, and which includes at least one additional layer between the two weldable surface layers.

The surface layers are constituted of at least one sealable copolyamide. These per se known copolyamides are produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine. The wall thickness of each surface layer is between 5 and 16 μm.

Surprisingly, addition of an amorphous polyamide and/or homopolyamide and/or of a modified polyolefin to a copolyamide in the surface layer significantly increases the seal seam strength compared to pure copolyamide, and high seal seam strength is achieved even at low sealing temperatures. Consequently, the film of the invention presents considerable technological advantages.

Polyamides having a glass transition temperature between 50 and 200° C. in dry state are used as amorphous polyamides for the surface layer. Examples are polyamide 6I/6T, polyamide 6-3-T and polyamide 6I.

Polyamides which can be produced from the same monomers as the copolyamides described above are used as homopolyamides for the surface layer. The homopolyamides can be both aliphatic and partially aromatic in character.

The modified polyolefins are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon.

The major component of each surface layer is a sealable copolyamide or a mixture of sealable copolyamides, said major component being present in amounts of between 50 and 95 wt.-%. The other components, amorphous polyamide, homopolyamide and modified polyolefin, can be admixed to the major component in amounts of from 0 to 30 wt.-%, relative to the overall surface layer.

At least one additional layer is situated between the two surface layers of the flat film according to the invention. The additional layer or layers arranged between the two surface layers serve to provide the flat film with further desirable properties, in addition to weldability, such as high barrier to oxygen and water vapor, high puncture resistance, or good mechanical properties.

Materials capable of forming the layers between the two surface layers are polyamides, polyolefins, modified polyolefins, and ethylene-vinyl alcohol copolymers. Mixtures of these materials with each other can also be used. Where adjacent layers do not have sufficient adhesion to each other, additional layers of adhesion promoters can be present.

The polyamides as intermediate layer can be homo- and/or copolyamides produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine. Preferred homo- and copolyamides are polyamide 6, polyamide 12, polyamide 610, polyamide 612, polyamide MXD6, polyamide 6/66, polyamide 6/12, and polyamide 6I/6T. The wall thickness of the polyamide intermediate layer is between 5 and 30 μm.

The polyolefins as intermediate layer are homopolymers of ethylene or propylene and/or copolymers of linear α-olefins having from 2 to 8 C atoms. Linear low-density polyethylene, high-density polyethylene, polypropylene homopolymer, polypropylene block copolymer and polypropylene random copolymer are preferably used for this layer. The wall thickness of the polyolefin intermediate layer is between 5 and 30 μm.

The modified polyolefins used as intermediate layer are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof. Furthermore, the modified polyolefins can be modified homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon. The wall thickness of the intermediate layer of modified polyolefin is between 5 and 30 μm.

The ethylene-vinyl alcohol copolymers used as intermediate layer are produced by complete saponification of copolymers of ethylene and vinyl acetate. In general, the amount of ethylene in the ethylene-vinyl alcohol copolymers is between 27 and 48 mole-%. For the intermediate layer, ethylene-vinyl alcohol copolymers are preferred, wherein the amount of ethylene is between 34 and 48 mole-%. The wall thickness of the intermediate layer of ethylene-vinyl alcohol copolymer is between 3 and 20 μm.

Where adhesion promoters are used in the intermediate layer, these adhesion promoters are homo- or copolymers of ethylene and/or propylene and optionally other linear α-olefins having from 3 to 8 C atoms, which have monomers from the group of α,β-unsaturated dicarboxylic acids, preferably maleic acid, fumaric acid, itaconic acid, or anhydrides, esters, amides or imides thereof grafted thereon.

Optionally, one or more layers of a laminating adhesive are situated between the two surface layers of the flat film according to the invention, which adhesive is used to bond the single films together, from which the inventive multilayered flat film is produced by laminating.

Preferred sequences of the single layers in the multilayered flat film of the invention are set forth below, wherein the letters, numbers and characters have the following meanings:

| | |
|---|---|
| A: | Weldable surface layer |
| B: | Polyamide intermediate layer |
| C: | Polyolefin intermediate layer |
| D: | Modified polyolefin intermediate layer |
| E: | Ethylene-vinyl alcohol intermediate layer |
| F: | Adhesion-promoting intermediate layer |
| //: | Laminating plane |

The numerical indices 1,2, . . . denote multiple layers from the same class of raw materials.

Three-layered structure:

:A₁//BA₂; A₁//C//A₂; A₁//EA₂

Four-layered structure:

A₁B//DA₂; A₁B//EA₂; A₁D//EA₂; A₁B//C//A₂

Five-layered structure:

AₗF₁C//DA₂; A₁F₁B//EA₂; A₁D//BEA₂; A₁//B₁EB₂//A₂; A₁B//C//EA₂; A₁B₁//C//B₂A₂; A₁//B₁B₂B₃//A₂

Six-layered structure:

A₁EB//CFA₂; A₁F₁E//BF₂A₂; A₁D₁E//BD₂A₂; A₁F₁C//EF₂A₂; A₁F₁C//BFA₂, A₁F₁B₁//B₂F₂A₂ ; A₁D//B₁B₂B₃//A₂ ; A₁FB₁//B₂EA₂ ; A₁D//B₁EB₂//A₂

Seven-layered structure:

A₁D₁//B₁EB₂//D₂A₂; A₁F₁C//BEF₂A₂; A₁D₁//B₁B₂B₃//D₂A₂; A₁F₁C₁//B//C₂F₂A₂; A₁F₁B₁//C//B₂F₂A₂

In addition, conventional auxiliary agents such as antiblocking agents, stabilizers, antistatic agents or lubricants can be included in the flat film. These auxiliary agents are normally added in amounts of from 0.1 to 5 wt.-%. Furthermore, the film can be colored by adding pigments or pigment mixtures.

The starting films for laminating can be imprinted. Where the print is on that side of the starting film on which another film is applied during laminating, the print in the final laminated film will be situated in an intermediate layer, thereby being protected against damage during further processing of the film.

The flat films according to the invention are produced by laminating at least two flat films which, in turn, can be single-layered or multilayered--and biaxially oriented. To this end, the single films are bonded in a laminating plant by pressing and optionally applying a laminating adhesive, so that the layers, the major component of which being a sealable copolyamide, furnish the two surface layers of the laminated flat film. According to this method, it is possible to produce broad flat films which are unduly broad to be used for packaging and wrapping foodstuffs. In this case, it is possible to cut the broad flat films along the length thereof to form blanks smaller in width which then can be welded to form tubular films having the desired dimensions.

The tubular films of the invention have an overall wall thickness of from 30 to 100 μm, preferably from 40 to 80 μm.

The weld seam strength of the tubular films according to the invention and of a Comparative Example were determined. To determine the weld seam strength, strips 50 mm in width were taken from each flat film at a right angle to the machine direction. Two strips at a time were welded together, where firstly, the surface layer 1 was welded on surface layer 2 in overlap (welding method 1) and secondly, the surface layer 1 was welded on surface layer 1 one on top of the other (welding method 2). An SGPE 20 laboratory welding apparatus from W. Kopp Verpackungsmaschinen was used as welding tool. Strips 25 mm in width were taken from the welded samples in such a way that the weld seam was at a right angle to the length of the strip. The strip samples were stretched on a tensile testing machine from Instron Company at a stretching rate of 500 mm/min until breaking of the weld seam occurred. The resulting maximum force will be referred to as weld seam strength hereinafter.

At a sealing temperature of 120° C., the flat films of the invention, welded according to welding method 1, showed a weld seam strength significantly higher than that of the Comparative Example. At sealing temperatures of 180° C. and 200° C., the specimen produced according to welding method 2 achieved significantly improved weld seam strength as compared to the Comparative Example.

The invention well be illustrated in more detail with reference to the following examples.

### EXAMPLE 1

Two three-layered, biaxially oriented, coextruded flat films were laminated into a six-layered flat film on a laminating plant using a laminating adhesive, and the sealable layers (1^{st} layer each time) formed the two outer surfaces of the resulting flat film.

The layer structure of the three-layered starting films was as follows:

| | |
|---|---|
| Film 1: | |
| 1^{st} layer: | Blend of 90% polyamide 6/12, Grilon CF6S from EMS |
| | Chemie and 10% ionomer resin, Surlyn 1652 from |
| | Du Pont de Nemours GmbH, 10 μm |
| 2^{nd} layer: | Adhesion promotor, modified polyethylene, Bynel 4140 from |
| | Du Pont de Nemours GmbH, 7 μm |
| 3^{rd} layer: | Polyethylene (LLDPE), Dowlex 2049 E from |
| | DOW Chemical Company, 13 μm |
| Film 2: | |
| 1^{st} layer: | Blend of 90% polyamide 6/12, Grilon CF6S from EMS |
| | Chemie and 10% ionomer resin, Surlyn 1652 from |
| | Du Pont de Nemours GmbH, 10 μm |
| 2^{nd} layer: | Adhesion promotor, modified polyethylene, Bynel 4140 from |
| | Du Pont de Nemours GmbH, 7 μm |
| 3^{rd} layer: | Polyamide 6, Durethan B40 F from Bayer AG, 13 μm |

The following weld seam strength values were determined:

Welding method 1:

Sealing temperature 120° C.: 183 N/25 mm

Sealing temperature 200° C.: 116 N/25 mm

Welding method 2:

Sealing temperature 180° C.: 94 N/25 mm

Sealing temperature 200° C.: 95 N/25 mm

### EXAMPLE 2

Two three-layered, biaxially oriented, coextruded flat films were laminated into a six-layered flat film on a laminating plant using a laminating adhesive, and the sealable layers (1^{st} layer each time) formed the two outer surfaces of the resulting flat film.

The layer structure of the three-layered starting films was as follows:

| | |
|---|---|
| Film 1: | |
| 1^{st} layer | Blend of 85% polyamide 6/12, Grilon CF6S from EMS |
| | Chemie and 5% polyamide 6I/6T, Grivory G21 from EMS |
| | Chemie and 10% ionomer resin, Surlyn 1652 from Du |
| | Pont de Nemours GmbH, 10 μm |
| 2^{nd} layer: | Adhesion promotor, modified polyethylene, Bynel 4140 from |
| | Du Pont de Nemours GmbH, 7 μm |
| 3^{rd} layer: | Polyethylene (LLDPE), Dowlex 2049 E from DOW |
| | Chemical Company, 13 μm |
| Film 2: | |
| 1^{st} layer | Blend of 85% polyamide 6/12, Grilon CF6S from EMS |
| | Chemie and 5% polyamide 6I/6T, Grivory G21 from EMS |
| | Chemie and 10% ionomer resin, Surlyn 1652 from Du |
| | Pont de Nemours GmbH, 10 μm |
| 2^{nd} layer: | Ethylene-vinyl alcohol copolymer, Soarnol AT4406 from |
| | Nippon Gohsei, 6 μm |
| 3^{rd} layer: | Polyamide 6, Durethan B40 F from Bayer AG, 13 μm |

The following weld seam strength values were determined:

Welding method 1:

Sealing temperature 120° C.: 192 N/25 mm

Sealing temperature 200° C.: 116 N/25 mm

Welding method 2:

Sealing temperature 180° C.: 88 N/25 mm

Sealing temperature 200° C.: 97 N/25 mm

### COMPARATIVE EXAMPLE

A six-layered flat film was produced from two three-layered films as in Example 1, with the exception that each first layer of both three-layered films was comprised of pure polyamide 6/12, Grilon CF6S from EMS Chemie.

The following weld seam strength values were determined:

Welding method 1:

Sealing temperature 120° C.: 167 N/25 mm

Sealing temperature 200° C.: 113 N/25 mm

Welding method 2:

Sealing temperature 180° C.: 77 N/25 mm

Sealing temperature 200° C.: 79 N/25 mm

1. A multilayered, weldable flat film for the production of welded tubular films, characterized in that both surface layers of the flat film can be welded and are comprised of at least one copolyamide and at least one amorphous polyamide and/or at least one homopolyamide and/or at least one modified polyolefin, which flat film is produced by laminating at least two flat films which, in turn, can be single-layered or multilayered and optionally biaxially oriented.

2. The flat film according to claim 1, characterized in that the copolyamides of the surface layers are produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

3. The flat film according to claim 2, characterized in that the copolyamides in each surface layer are present in amounts of from 50 to 95 wt.-%.

4. The flat film according to any of claims 1 to 3, characterized in that the surface layers include amorphous polyamides having a glass transition temperature between 50 and 200° C. in dry state.

5. The flat film according to claim 4, characterized in that the glass transition temperature of the amorphous polyamides is preferably between 90 and 160° C.

6. The flat film according to any of claims 1 to 5, characterized in that the surface layers include homopolyamides produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

7. The flat film according to any of claims 1 to 6, characterized in that the surface layers include modified polyolefins, which polyolefins are copolymers of ethylene or propylene and optionally other linear α-olefins having from 3 to 8 C atoms and α,β-unsaturated carboxylic acids, preferably acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

8. The flat film according to claims 1 to 7, characterized in that each other component included in the surface layer, amorphous polyamide, homopolyamide and modified polyolefin, can be admixed in amounts of from 0 to 30 wt.-%, relative to the respective surface layer.

9. The flat film according to claims 1 to 8, characterized in that the wall thickness of each surface layer is between 5 and 16 μm.

10. The flat film according to claim 1, characterized in that at least one additional layer is situated between the surface layers.

11. The flat film according to claims 1 to 10, characterized in that the additional layer or layers arranged between the surface layers are comprised of materials or mixtures thereof selected from the groups of polyamides, polyolefins, modified polyolefins, and ethylene-vinyl alcohol copolymers.

12. The flat film according to claims 1 to 11, characterized in that the additional layer of polyamide arranged between the surface layers is comprised of at least one homopolyamide and/or at least one copolyamide produced from monomers selected from the group of caprolactam, laurinlactam, ω-aminoundecanoic acid, adipic acid, azelaic acid, sebacic acid, decanedicarboxylic acid, dodecanedicarboxylic acid, terephthalic acid, isophthalic acid, tetramethylenediamine, pentamethylenediamine, hexamethylenediamine, octamethylenediamine, and xylylenediamine.

13. The flat film according to claim 12, characterized in that the wall thickness of the polyamide layer is between 5 and 30 μm.

14. The flat film according to claims 1 to 13, characterized in that the additional layer of polyolefin arranged between the surface layers is constituted of homopolymers of ethylene or propylene and/or of copolymers of linear α-olefins having from 2 to 8 C atoms.

15. The flat film according to claim 14, characterized in that the wall thickness of the polyolefin layer is between 5 and 30 μm.

16. The flat film according to claims 1 to 17, characterized in that the additional layer of modified polyolefin arranged between the surface layers is constituted of copolymers of ethylene or propylene and optionally other linear α-olefins having from 3 to 8 C atoms and α,β-unsaturated carboxylic acids such as acrylic acid, methacrylic acid and/or metal salts and/or alkyl esters thereof, or appropriate graft copolymers of the above-mentioned monomers on polyolefins, or partially saponified ethylene-vinyl acetate copolymers which are optionally graft-polymerized with an α,β-unsaturated carboxylic acid and have a low saponification level, or mixtures thereof.

17. The flat film according to claim 16, characterized in that the wall thickness of the modified polyolefin layer is between 5 and 30 μm.

18. The flat film according to claims 1 to 14, characterized in that the additional layer of ethylene-vinyl alcohol copolymer arranged between the surface layers includes a copolymer wherein the amount of ethylene is between 27 and 48 mole-%, preferably between 34 and 48 mole-%.

19. The flat film according to claim 18, characterized in that the wall thickness of the ethylene-vinyl alcohol copolymer layer is between 3 and 20 μm.

20. The flat film according to claims 1 to 19, characterized in that modified homo- or copolymers of ethylene and/or propylene and optionally other linear α-olefins having from 3 to 8 C atoms, which have monomers from the group of α,β-unsaturated dicarboxylic acids such as maleic acid, fumaric acid, itaconic acid, or anhydrides, esters, amides or imides thereof grafted thereon, are used as adhesion promoters.

21. The flat film according to claim 20, characterized in that the wall thickness of the adhesion-promoting layer is between 3 and 20 μm.

22. The flat film according to claims 1 to 21, characterized in that the overall wall thickness is from 30 to 100, preferably from 40 to 80 μm.

23. A multilayered, weldable flat film, produced by laminating at least two flat films.

24. Use of a flat film according to any of claims 1 to 23 in the production of a tubular film.

25. Use of a tubular film according to claim 24 for the packaging and wrapping of foodstuffs.
